(19) United States
(12) Patent Application Publication
(10) Pub. No.: US 2014/0138402 A1
(43) Pub. Date: May 22, 2014

(54) INSULATED FLUID DISPENSING SYSTEM

(71) Applicants: Ryan Warren, Los Angeles, CA (US); Tyler Haggstrom, Los Angeles, CA (US); Allen Starnes, Glendale, CA (US)

(72) Inventors: Ryan Warren, Los Angeles, CA (US); Tyler Haggstrom, Los Angeles, CA (US); Allen Starnes, Glendale, CA (US)

(21) Appl. No.: 14/082,317

(22) Filed: Nov. 18, 2013

Related U.S. Application Data
(63) Continuation-in-part of application No. 29/471,838, filed on Nov. 5, 2013.
(60) Provisional application No. 61/728,171, filed on Nov. 19, 2012.

(51) Int. Cl. B67D 7/10; B67D 7/06; B67D 1/00

(52) U.S. Cl. CPC B05C 11/1021
USPC 222/2; 222/52; 222/183

(57) ABSTRACT

A thermally insulated fluid dispensing system that maintains the temperature of fluid to be automatically dispensed to a user in a measured amount upon an object detecting pump actuator of the system sensing an object, such as a hand or container, placed adjacent to a fluid dispensing aperture of a fluid dispenser.

This application claims the benefit of priority to U.S. provisional patent application 61/728,171 filed on Nov. 19, 2012, and U.S. non-provisional design patent application 29/471,838 filed on Nov. 5, 2013, the contents of which are hereby incorporated by reference.

### BACKGROUND OF THE INVENTION

The present invention relates to systems for dispensing measured amounts of fluid, and more particularly to systems that dispense measured amounts fluid in an outdoor environment upon being activated by the presence of a fluid receiving object, such as for example a hand or container.

There is frequently a need in outdoor locations for the availability of liquid products to be used by persons at the outdoor location. For example, it is well known that overexposure to the sun can lead to sunburns and skin cancers, and that it is therefore desirable for those participating in outdoor activities or events to apply sunscreen lotion to the areas of their skin that are exposed to the sun during such activities or events. Yet for such participants to carry their own supply of sunscreen with them during an event or activity can be inconvenient. The availability of an accessible and sanitary dispenser of sunscreen lotion available for use by participants at an outdoor activity or event is therefore desirable.

However, a sunscreen lotion dispenser provided at an outdoor location will be subject to the outdoor elements, such as for example prolonged exposure in the sun, and/or in the case of outdoor winter activities cold temperatures. Such exposure to the outdoor elements can adversely affect the properties of the sunscreen lotion to be dispensed, including but not limited to changing the temperature of the sunscreen lotion such that the chemical properties of the sunscreen lotion may be affected and/or it becomes uncomfortable for a user to apply. Accordingly, there is a need for a way to provide a fluid dispenser at an outdoor location which is exposed to the elements in a convenient and sanitary way while maintaining the fluid to be dispensed (e.g. sunscreen lotion, hand sanitizer, insect repellent, etc . . . ) at an appropriate temperature.

There is also a need for the dispenser to be configured so as to minimize the waste of fluid being dispensed, and guard against such fluid disturbing or polluting the environment surrounding the dispenser, such as for example dripping onto the ground beneath the dispenser. The dispenser should also be easy for the provider to maintain and replenish the fluid being dispensed.

These and other objects are achieved through the insulated fluid dispensing system described and illustrated herein.

### BRIEF SUMMARY OF THE INVENTION

The present invention is a fluid dispensing system having a fluid dispenser that incorporates an object detecting pump actuator that activates a pump to dispense a measured amount of fluid from a fluid container to a user upon the automatic detection of an object, such as a hand or container, placed adjacent to a fluid dispensing aperture in the fluid dispenser. The object detecting pump actuator preferably uses motion or proximity sensing technology that is resistant to interference from environmental factors such as sunlight, acoustic noise, or mechanical vibrations.

In a key aspect of the present invention the fluid to be dispensed from the fluid container is protected against changes in temperature by use of one or more thermal insulators incorporated into the fluid container and/or fluid dispenser housing.

In a preferred embodiment the fluid container of the system is thermally insulated by having a double walled shell containing a gap between an inner wall and an outer wall of the shell. The inner and outer walls of the fluid container shell are comprised of a material, such as polyurethane, which has a high thermal resistance. The gap between the inner wall and the outer wall is preferably a full or partial vacuum. In this way the fluid container acts like thermos to help maintain the temperature of the fluid to be dispensed. It is contemplated that the separate housing of the fluid dispenser itself may also incorporate such a double walled feature to further insulate the fluid from temperature changes.

In addition to providing the fluid container and/or fluid dispenser housing with one or more thermal insulators to protect against fluid temperature changes caused by environmental factors, it is contemplated the fluid dispensing system of the present invention may use temperature regulator means to maintain the temperature within the fluid dispenser housing in a desired range. Such temperature regulator means may have passive and/or active elements.

In a preferred embodiment of the fluid dispensing system of the present invention the fluid container used by the system is easily removable as a unit from the fluid dispenser housing. This facilitates the easy replenishment of fluid to be dispensed by the simple removal of empty fluid containers and replacement with full fluid containers. It also facilitates the ability to change the fluid being dispensed by the system by simply replacing a fluid container having one type of fluid, with a fluid container having another kind of fluid to be dispensed. The system may also be cleaned periodically by placing a fluid container containing a cleaning solution (e.g. a gentle solvent) which can be used to flush the system. It is contemplated that fluid containers removed from the fluid dispenser after fluid depletion may be cleaned, refurbished, and/or again filled with fluid so as to be re-used by the system.

The fluid dispensing system of the present invention is also contemplated to include a fluid level indicator to allow knowledge of the amount of fluid remaining in the system to be dispensed. In a preferred embodiment of the present invention the fluid dispenser housing has a viewing port and a fluid container that is transparent, or has a transparent portion that is adjacent to the viewing port, such that a user may directly observe the amount of fluid remaining in the fluid container.

The fluid dispensing system of the present invention is contemplated to incorporate a drip catcher beneath the fluid dispensing aperture of the fluid dispenser to prevent any excess fluid not captured by the detected object from polluting or disturbing the environment. It is further contemplated that a payment system may be incorporated into the fluid dispensing system where payment must be provided prior to fluid being dispensed by the system.

The preferred embodiment of the fluid dispensing system of the present invention is further contemplated to be powered by batteries, and have a housing that is resistant to damage or degradation from being located at an outdoor event or activity and being exposed to outdoor elements (e.g. water, salt, heat, cold, etc . . . ).

What follows is a more detailed description of preferred embodiments of the fluid dispensing system of the present invention.

### BRIEF DESCRIPTION OF THE SEVERAL VIEWS OF THE DRAWINGS

FIG. 1 is a front perspective sectional view of the fluid dispensing device.

FIG. 2 is a front sectional view of a double walled fluid container.

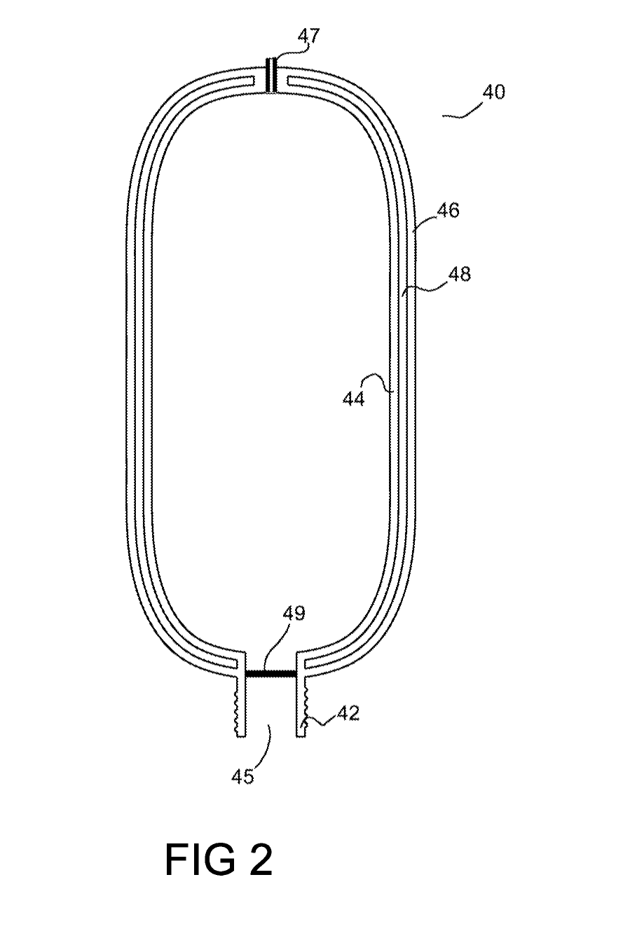

FIG. 3 is a right front perspective view of the fluid dispensing device.

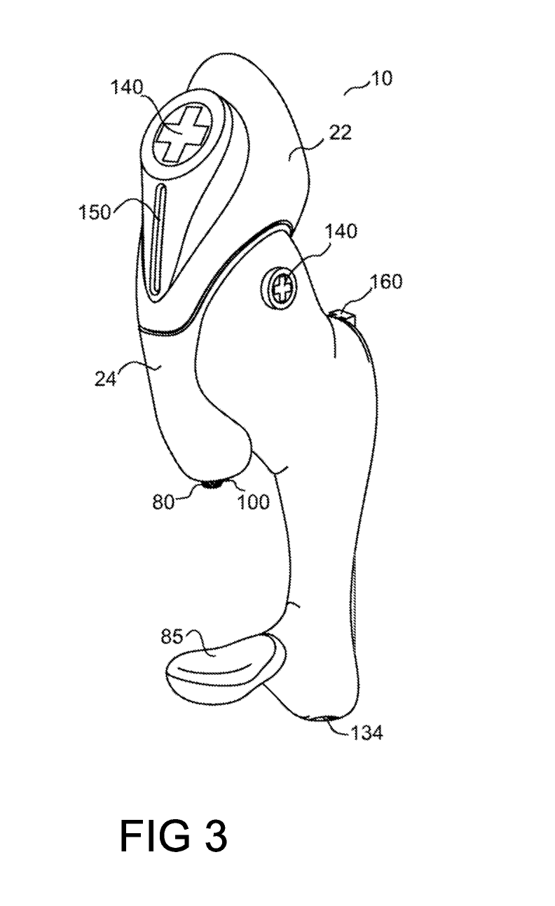

### DETAILED DESCRIPTION OF THE INVENTION

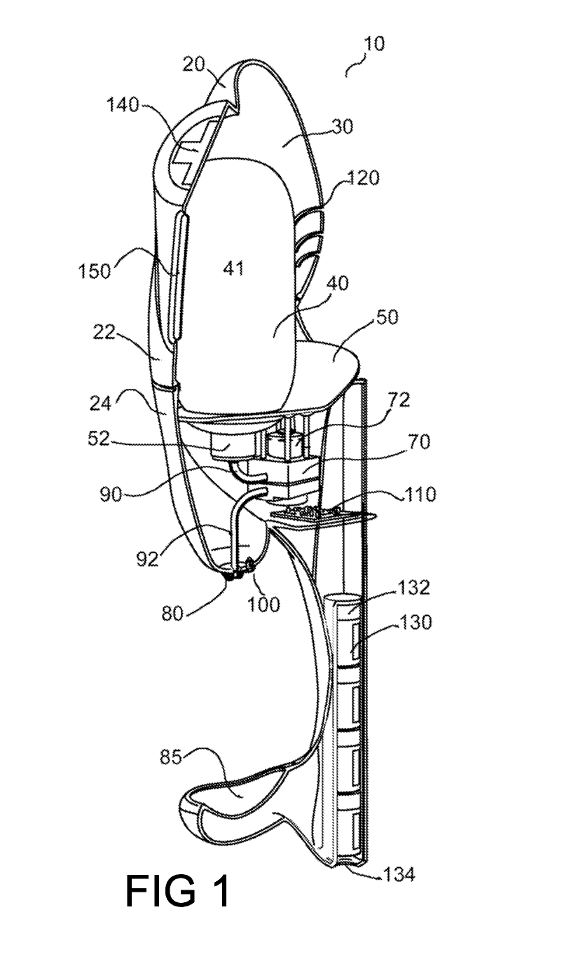

Referring to FIG. 1, in a preferred embodiment of the present invention for a fluid dispensing system there is a fluid dispenser 10 there is a housing 20. Housing 20 may have an upper portion 22 and a lower portion 24. Preferably upper portion 22 is attached to lower portion 24 such that it can be manually removed, at least in part, from lower portion 24. To accomplish this upper portion 22 may, for example, be attached to lower portion 24 by a hinge, a threaded coupling, or a simple friction fit. There is a compartment 30 within housing 20. In the preferred embodiment shown in FIG. 1 compartment 30 is located substantially within the volume of space that is bounded by upper portion 22 when it is attached to lower portion 24.

A fluid container 40 is positioned within compartment 30. Fluid container 40 is positioned within compartment 30 at least in part by a fluid container support 50. Fluid container support 50 may, for example, be in the form of a horizontal plate within housing 20 that is located between upper portion 22 and lower portion 24, and upon which fluid container 40 is placed. Fluid container support 50 may be a separate component mechanically attached to an inner wall of housing 20, or may be an integrally molded part of housing 20 such as an inward extension of the inner wall of lower portion 24 of housing 20. Fluid container 40 may be permanently attached to, or even an integral molded part of, fluid container support 50. Alternatively, fluid container 40 may be removably attached to fluid container support 50 such that fluid container 40 can be removed from compartment 30 for refill or replacement. In such an exemplary embodiment it is contemplated that fluid container 40 may have a male threaded flange 42 that would be joined with a female threaded opening 52 in fluid container support 50, although any other type of removable attachment means may be used as well.

Fluid container 40 functions to contain a fluid for dispensing by the fluid dispenser 10. In a preferred embodiment the fluid is a sunscreen lotion. However, the present invention may be used to contain and dispense any other fluid such as, for example, aloe vera, insect repellent, moisturizer, hand sanitizer, soap, shampoo, hair conditioner, and condiments (e.g. ketchup, mustard, etc . . . ).

Fluid container 40 is contemplated to be comprised of at least one shell 41 having a fluid outlet 45 and a pressure-equalizing vent 47 to facilitate removal of fluid from fluid container 40. Pressure-equalizing vent 47 may in some embodiments simply be an unobstructed opening through shell 41 between the ambient atmosphere and the fluid within fluid container 40. In other embodiments pressure-equalizing vent 47 may have a plastic or silicon valve assembly that allows the passage of air when there is a difference between the ambient pressure and pressure within fluid container 40. Fluid outlet 45 is contemplated to have a sealing membrane 49 to keep fluid within fluid container 40 from leaking out of fluid outlet 45. In a preferred embodiment sealing membrane 49 may be comprised of a thin plastic or foil that is adhesively attached to flange 42 that surrounds fluid outlet 45. Shell 41 may be rigid (e.g. such that fluid container 40 is in the form of a bottle) or may be pliable (e.g. such that fluid container 40 is in the form of a bag).

It is contemplated in one embodiment that fluid container 40 may be comprised of a rigid outer shell (e.g. a bottle) that contains a pliable fluid bladder (e.g. a plastic bag), which may or may not be removable from said rigid outer shell. It is contemplated that the pliable fluid bladder would have a fluid outlet, a sealing membrane, and a pressure-equalizing vent.

In a preferred embodiment of the present invention it is contemplated that fluid container 40 would be a distinct unit such that it may be packaged, sold and/or stored separately from fluid dispenser 10. In such an embodiment the fluid being dispensed by fluid dispenser 10 may be replenished or replaced by simply replacing a fluid container 40 in the fluid dispenser 10 with a new fluid container 40 having a full supply of the desired fluid to be dispensed. In an alternative contemplated embodiment, fluid container 40, which may or may not be permanently mounted within fluid dispenser 10, may be provided with a refill port for facilitating the adding of fluid to fluid container 40 without removing fluid container 40 from fluid dispenser 10. In some embodiments such a refill port may be left open to the surrounding atmosphere so as to act as a pressure-equalizing vent during dispensing of fluid from fluid container 40.

In a key aspect of the present invention changes to the temperature of the fluid contained within fluid container 40 caused by external environmental conditions are controlled by thermally insulating and/or actively regulating the temperature of the fluid. In a preferred embodiment of the present invention this is accomplished at least in part by fluid container 40 by providing shell 41 with thermal insulating properties. By way of example, in a single walled embodiment shell 41 may simply be comprised of a material having good thermal insulating properties, such as for example polyurethane.

However, in a preferred embodiment insulated fluid container 40 has a shell 41 that is double-walled; specifically having a thermal barrier 48 located in between an inner wall 44 and an outer wall 46. It is contemplated that inner wall 44 and outer wall 46 would be comprised of a material that has good thermal insulating properties like polyurethane. Thermal barrier 48 between inner wall 44 and outer wall 46 would preferably be a full, or at least a partial, vacuum such that fluid container 40 acts like a thermos to keep the temperature of the contained fluid constant. However, thermal barrier 48 may also be air or any number of substances or materials with thermal insulating properties including, but not limited to, foil-faced polyurethane, foil-faced polystyrene, foil-backed bubble pack, fiberglass, high density fiberglass, natural fibers (e.g. cork, cotton, hemp, flax, coco, rock and slag wool, wool, wood fiber, cellulose, seaweed, straw), vermiculite, perlite, silica foam, or silica aerogel. Plant based waste materials such as nut shells or corn cobs may also be used.

In addition to, or instead of, a fluid container 40 with a shell 41 provided with thermal insulating properties, it is further contemplated that the housing 20 of fluid dispenser 10 may be provided with thermal insulating properties. By way of example, housing 20 may be single walled and comprised of a material that has good thermal insulating properties, such as for example, polyurethane. Housing 20 may also be double-walled; having a housing thermal barrier located in between an inner housing wall and an outer housing wall. The thermal barrier between the inner housing wall and outer housing wall would preferably be a full, or at least a partial, vacuum such that insulated fluid container acts like a thermos to keep the temperature of the contained fluid constant. However, the housing thermal barrier may also be air or any number of substances or materials with thermal insulating properties including, but not limited to, foil-faced polyurethane, foil-faced polystyrene, foil-backed bubble pack, fiberglass, high density fiberglass, natural fibers (e.g. cork, cotton, hemp, flax, coco, rock and slag wool, wool, wood fiber, cellulose, seaweed, straw), vermiculite, perlite, silica foam, or silica aerogel. Plant based waste materials such as nut shells or corn cobs may also be used.

It is further contemplated that the fluid contained within fluid container 40 may be insulated against temperature changes by providing housing 20 with a heat reflective surface, such as for example having the outer surface of housing 20 colored white. It should be noted that fluid container 40 may also have an outer surface of shell 41 with heat reflective properties, such as for example being colored white.

It is further contemplated that in addition to, or instead of, controlling temperature changes of the fluid by way of providing insulation from the external environment, that the present invention may utilize a temperature regulator means. Such temperature regulator means may have passive elements, such as for example simple air vents 120 in housing 20 that permit the circulation of air between the interior and exterior of housing 20. Such a temperature regulator means may also have active elements to monitor the temperature within housing 20 and maintain the temperature within a desired range inside of housing 20. By way of example temperature regulator means could include an electrically powered fan and associated thermostat element for activating the fan to circulate air between the interior and exterior of housing 20, thus removing heat from fluid dispenser 10. Another example would be one or more thermoelectric elements operating in accordance with the Peltier effect used in combination with feedback control circuitry to maintain the temperature within housing 20 in a desired range. An example of such feedback control circuitry for a Peltier element is found in U.S. Pat. No. 5,515,682 to Nagakubo et al for a “Peltier control circuit and a peltier device structure” the contents of which are hereby fully incorporated by reference. It is contemplated that any active elements of the temperature regulator may be electrically powered, and receive such electrical power from batteries, solar cells, and/or a plug in alternating current source.

Within housing 20 is a pump assembly 70 for pumping a measured volume of the fluid in fluid container 40 through tubes out of an aperture 80 in housing 20. It is contemplated that the measured volume of fluid moved by pump assembly 70 shall be determined by the length of time pump assembly 70 is activated for. Pump assembly 70 may include a direct or indirect drive motor. It is contemplated that fluid dispenser 10 has a fluid output control switch that may be used to determine the settings of pump assembly 70 so as to adjust the time that pump assembly is activated and hence the measured volume of fluid that is dispensed. For example, such a fluid output control switch may be a mechanical switch with different settings, located either internally within housing 20, or be accessible on an outer surface of housing 20. The fluid output control switch may, if associated with an electronic controller or microprocessor (e.g. controller 110), also be a conventional DIP switch. The fluid output control switch may be set such that when activated pump assembly 70 pumps for a predetermined period of time corresponding to a certain volume of fluid.

Pump tube 90 punctures sealing membrane 49 on fluid container 40 to make contact with the fluid contained in fluid container 40. Pump tube 90 may, by way of example and not limitation, be plastic or silicon. Pump assembly 70 may be powered by a direct or indirect motor 72 which when activated exerts a force to move a measured quantity of fluid from fluid container 40 through tube 90, through pump 70, and through dispensing tube 92 to aperture 80. Dispensing tube 92 may, by way of example and not limitation, be plastic or silicon. Pump 70 is controlled by an electronic controller 110 which activates and deactivates pump 70.

In electronic communication with electronic controller 110 is object detecting pump actuator 100. Object detecting pump actuator 100 senses when an object (e.g. a hand, a container, etc . . . ) moves adjacent to aperture 80. In a preferred embodiment of the present invention for use outdoors in bright sunlight conditions object detecting pump actuator 100 should be a motion or proximity detector that is resistant to being activated by environmental interferences such as direct sunlight, acoustic noise, or mechanical vibrations. Object detecting pump actuator may, by way example and not limitation, use infrared, microwave, and/or acoustic motion or proximity detecting technologies, such as for example an active infrared beam motion detector. When an object is moved in adjacent proximity to aperture 80 this will be detected by object detecting pump actuator 100 which will send an electronic activation signal to controller 110 which will then activate pump 70 so as to pump a predetermined amount of fluid out of aperture 80. In a preferred embodiment there is a fluid catcher 85 positioned beneath aperture 80 to catch any fluid dispensed from aperture 80 that is not captured by the detected object which triggered the dispensing if fluid.

In a preferred embodiment of the present invention it is contemplated that the source of electrical power for electronic components used by fluid dispenser 10 would be batteries 130 located in a battery compartment 132. Preferably battery compartment 132 is physically separated from the other components of fluid dispenser 10 in order to protect the integrity of the power source. Battery compartment 132 is contemplated to have a battery compartment door 134 that is watertight and locked with a screw. Batteries 130 may be regular disposable alkaline batteries, or rechargeable batteries, which can be removed from battery compartment 132 and replaced. The use of batteries is contemplated for fluid dispensing devices that may be not be located near to an AC source of electrical power. However, the fluid dispenser of the present invention may also receive electrical power from any suitable source of electricity, including but not limited to an internal power supply that may be connected to an external DC or AC source of electrical power.

It is contemplated that the fluid dispenser of the present invention may have one or more identifying badges 140 which may be removably attached to housing 20 of fluid dispenser 10. It is contemplated that identifying badges 140 may be customized to display different logos or messages associated with the person or organization making the fluid dispenser 10 available for use at a given location.

Fluid dispenser 10 is also contemplated to include a fluid level indicator 150 which can be observed to learn the amount of fluid remaining in fluid dispenser 10. In a preferred embodiment it is contemplated that fluid level indicator 150 will be a clear viewing port 150 in upper portion 22 of housing 20 that will allow for direct observation of the fluid level in fluid container 40 (which will have at least a portion of shell 41 that is transparent or translucent adjacent to viewing port 150 so as to allow observation of the fluid within fluid container 40).

It is contemplated that fluid dispensing device 10 would be attached with a mounting means 160 to a vertical structure (e.g. a wall or a post) at a height convenient for the intended dispensation of liquid. The mounting means 160 may be a fastening component, such as for example a t-rail, for connecting with a compatible bracket mounting system secured (e.g. by way of screws) to the vertical structure.

It is further contemplated that housing 20 of fluid dispenser 10 would be rugged and durable for use in outdoor environments. Particularly, it is contemplated that housing 20 and any associated elements exposed to the environment may be water proof or water resistant, and comprised of materials that are not subject to corrosion when used in or near a marine environment (e.g. at the beach) for prolonged periods of time.

It is further contemplated that fluid dispenser 10 of the present invention may incorporate a payment mechanism where payment from user is required before fluid is dispensed. By way of example and not limitation, a user of fluid dispenser 10 may need to insert currency, a credit card, or other payment means before any signal from object detecting pump actuator 100 will be allowed to activate pump assembly 70.

While particular embodiments of the present invention have been shown and described, it will be obvious to those skilled in the art that based upon the teachings herein, that changes and modifications may be made without departing from this invention and its broader aspects. For example, while the illustrated embodiments are for a thermally insulated automatic sunscreen dispensing device the present invention is not limited to dispensing sunscreen. The present invention may be used to dispense any substance with sufficient fluidity to be pumped in measured amounts. Therefore, the appended claims are to encompass within their scope all such changes and modifications as are within the true spirit and scope of the invention.

1. A fluid dispensing system comprising:
a fluid dispenser with a housing;
a fluid container having a thermally insulating shell;
a pump assembly;
an object detecting pump actuator; and
a fluid dispensing aperture.

2. The fluid dispensing system of claim 1 wherein said thermally insulating shell comprises an inner shell wall, an outer shell wall, and a thermal barrier located between said inner shell wall and said outer shell wall.

3. The fluid dispensing system of claim 2 wherein said thermal barrier is substantially a vacuum.

4. The fluid dispensing system of claim 1 wherein said fluid container is removably attached to a fluid container support within said housing.

5. The fluid dispensing system of claim 1 further comprising a fluid bladder within said fluid container.

6. The fluid dispensing system of claim 1 further comprising a fluid level indicator.

7. The fluid dispensing system of claim 1 further comprising an identifying badge attached to an outer surface of said housing.

8. The fluid dispensing system of claim 1 wherein said housing has an inner housing wall, an outer housing wall, and a thermal barrier located between said inner housing wall and said outer housing wall.

9. The fluid dispensing system of claim 1 wherein said housing has a heat reflective outer surface.

10. The fluid dispensing system of claim 1 further comprising a temperature regulator means.

11. The fluid dispensing system of claim 1 further comprising a payment system.

12. A fluid dispensing system comprising:
a fluid dispenser with a thermally insulated housing;
a fluid container within said thermally insulated housing;
a pump assembly;
an object detecting pump actuator; and
a fluid dispensing aperture.

13. The fluid dispensing system of claim 12 wherein said thermally insulated housing has an inner housing wall, an outer housing wall, and a thermal barrier located between said inner housing wall and said outer housing wall.

14. The fluid dispensing system of claim 13 wherein said thermal barrier is substantially a vacuum.

15. The fluid dispensing system of claim 12 wherein said fluid container is removably attached to a fluid container support within said housing.

16. The fluid dispensing system of claim 12 further comprising a fluid bladder within said fluid container.

17. The fluid dispensing system of claim 12 further comprising a fluid level indicator.

18. The fluid dispensing system of claim 12 further comprising an identifying badge attached to an outer surface of said housing.

19. The fluid dispensing system of claim 12 further comprising a temperature regulator means.

20. The fluid dispensing system of claim 12 further comprising a payment system.
